(19) United States
(12) Patent Application Publication
(10) Pub. No.: US 2018/0315061 A1
(43) Pub. Date: Nov. 1, 2018

(54) UNIFIED METRICS FOR MEASURING USER INTERACTIONS

(71) Applicant: TUNE, Inc., Seattle, WA (US)

(72) Inventors: Lee Edward Brown, Seattle, WA (US); Lucas Roy Brown, Seattle, WA (US)

(21) Appl. No.: 15/582,141

(22) Filed: Apr. 28, 2017

(51) Int. Cl. G06Q 30/02; H04L 29/08

(52) U.S. Cl. CPC G06Q 30/0201; H04L 67/22

(57) ABSTRACT

Embodiments are directed to managing user interactions with applications. Entry points to a content distribution may be provided to content platforms, such that the entry points may be associated with a distribution identifier associated with an application identifier. Content data associated with the distribution identifier may be collected from a data store, such that the content data may be partially normalized to conform to a unified data model. Attribution data that may be produced by an application associated with the application identifier may be collected. The attribution data may be provided by a metrics engine of the application. The content data and the attribution data may be correlated based on the application identifier and the distribution identifier. Fields of the content data and the attribution data may be transformed into unified metric values. Reports based on the unified metric values may be provided.

### TECHNICAL FIELD

This invention relates generally to application monitoring services, and more particularly, but not exclusively, to measuring the user interactions with applications.

### BACKGROUND

The marketplace for applications is becoming increasingly competitive. Consumers have millions of different applications for many different platforms to choose from. In response to the explosion of the number of applications and market congestion, marketing services organizations have stepped forward to provide a variety of services to help application developers understand the marketplace in general as well as provide a better understanding of how their own customers (and potential customers) are responding to their offerings.

Accordingly, various user tracking solutions have been offered by services or organizations to provide information regarding how users interact with their applications. For example, organizations may track the web navigation history of users to determine information about their interests and/or interaction habits. Information gleaned from the tracking a user's web activity may be used to influence the how applications are designed. To help understand how users respond to particular content and particular content distributions that may be associated with applications, organizations may collect interaction information for various distributions and compare the results. However, as some distributions and/or user interactions may span more than one communication domain (e.g., web, mobile, print, or the like) or more than one disparate collection services it may be difficult to effectively evaluate user interactions that may occur across multiple domains or services. Thus, it is with respect to these considerations and others that the invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 shows a logical schematic embodiment of a client computer;

FIG. 3 illustrates a logical schematic embodiment of a network computer;

FIG. 4 illustrates a logical schematic of an analytics system in accordance with at least one of the various embodiments;

FIG. 5 illustrates a logical schematic of a system for unified analytics for measuring user interaction in accordance with one or more of the various embodiments;

FIG. 6A represents a logical schematic of a system for producing reports based on unified metrics in accordance with one or more of the various embodiments;

FIG. 6B represents a logical schematic of a data structure for associating distributions and applications in accordance with one or more of the various embodiments;

FIG. 7 represents a logical schematic of a system for producing unified metrics in accordance with one or more of the various embodiments;

FIG. 8 illustrates an overview flowchart for a process for unified metrics for measuring user interactions in accordance with at least one of the various embodiments;

FIG. 9 illustrates an overview flowchart for a process that collects content data from content platforms in accordance with at least one of the various embodiments;

FIG. 10 illustrates an overview flowchart for a process that provides unified metrics based on content platform data and attribution platform data in accordance with at least one of the various embodiments; and

FIG. 11 illustrates a flowchart for a process that normalizes content platform data for time and date in accordance with at least one of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. Also, throughout the specification and the claims, the use of “when” and “responsive to” do not imply that associated resultant actions are required to occur immediately or within a particular time period. Instead they are used herein to indicate actions that may occur or be performed in response to one or more conditions being met, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein, the term “connector agent” refers to an engine that is specialized for interfacing with one or more content platforms. Connector agents are arranged to employed one or more interfaces that are customized to conforming the interface requirements of particular content platforms. Connectors agents are arranged to collect activity data from disparate content platforms and transform it to conform to a unified metrics model, Accordingly, the conformed metrics may be collected later by a unified analytics engine.

As used herein, the term “content platform” refers to a commercial service arranged to distribute content to various digital media target platforms. For example, one content platform may provide content that may be included in web pages. While another content platform may display content with search engine search results. Some content platforms may display content on one or more social media platforms. Commonly, content platforms may be arranged to track activity related to individual content or content distributions. Tracked activity may include clicks, views/impressions, visit history, or the like. Accordingly, content platforms may provide data such as, activity information, cost information, or the like, for content distributions. In many cases, different the content platforms may enable their data to be accessed using proprietary APIs. Also, the provided data is often provided using proprietary formats.

As used herein, the term “attribution engine” refers to an engine that may be arranged to track user activity, including in-app purchases, that may occur on an application separate from content provided by a content platform.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing user interactions with applications over a network. In one or more of the various embodiments, one or more entry points to a content distribution may be provided to one or more content platforms, such that the one or more entry points may be associated with a distribution identifier that may be associated with an application identifier.

In one or more of the various embodiments, content data that may be associated with the distribution identifier may be collected from a data store, such that the content data may be partially normalized to conform to a unified data model.

In one or more of the various embodiments, attribution data that may be produced by an application that is associated with the application identifier may be collected. In one or more of the various embodiments, collecting the attribution data may include employing an attribution engine to accumulate the attribution data that may be provided by a metrics engine of the application, such that the attribute engine may be separate from the content platform.

In one or more of the various embodiments, the content data and the attribution data may be correlated based on the application identifier and the distribution identifier.

In one or more of the various embodiments, one or more of one or more fields of the attribution data, or one or more fields of the content data may be transformed into one or more unified metric values. In one or more of the various embodiments, transforming one or more of the one or more fields of the attribution data, or the one or more fields of the content data into the one or more unified metric values may include, including one or more metric values in one or more the unified metric values that may be unavailable to the content platform.

In one or more of the various embodiments, one or more reports based on the unified metric values may be provided. In one or more of the various embodiments, providing the one or more reports may include storing the one or more unified metric values in a data store and enabling one or more owners of the application to collect the one or more unified metric values for use in their own reports or visualizations.

In one or more of the various embodiments, one or more connector agents may be provisioned and employed to collect raw content data from one or more content platforms. In one or more of the various embodiments, the one or more connector agents may be employed to transform to the raw content data into content data that partially conforms to the unified data model. And, in one or more of the various embodiments, the one or more connector agents may be employed to store the content data on the remote data store.

In one or more of the various embodiments, one or more of, one or more timestamp values associated with the content data, or one or more timestamp values associated with the attribution data may be transformed to conform to a configured time format.

In one or more of the various embodiments, one or more credentials that enable authorized access to the content platform may be provided. In one or more of the various embodiments, the one or more credentials may be associated with the content distribution. And, in one or more of the various embodiments, the one or more credentials may be communicated over a network to one or more connector agents that may be arranged to collect raw content data from the content platform.

### Illustrated Operating Environment

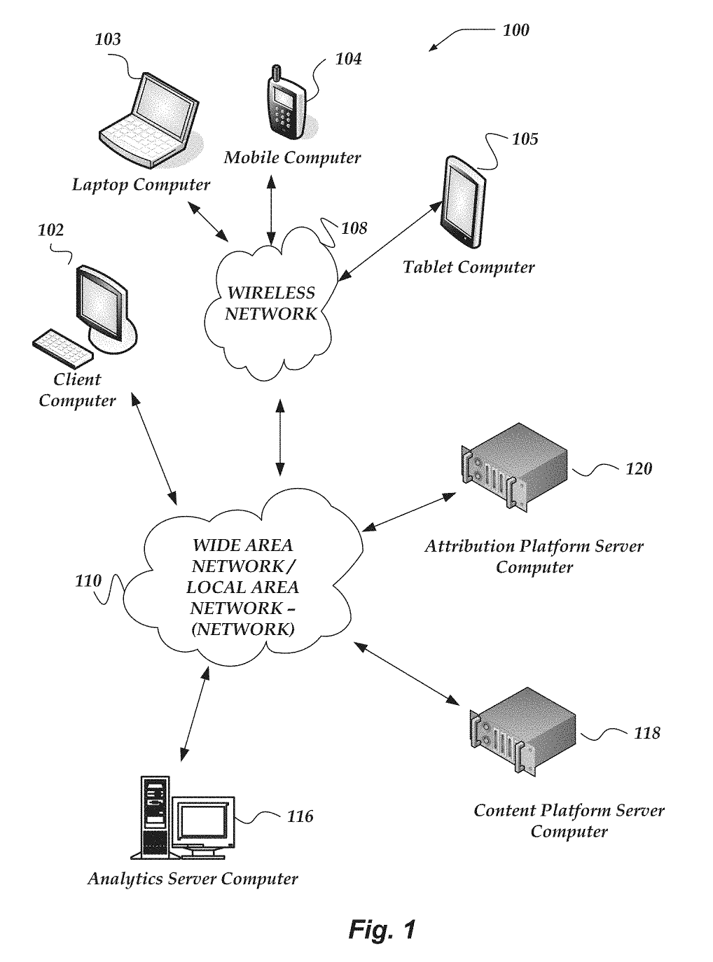

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/ wide area networks (WANs)—(network) 110, wireless network 108, client computers 102-105, analytics server computer 116, content platform server computer 118, attribution platform server computer 120, or the like.

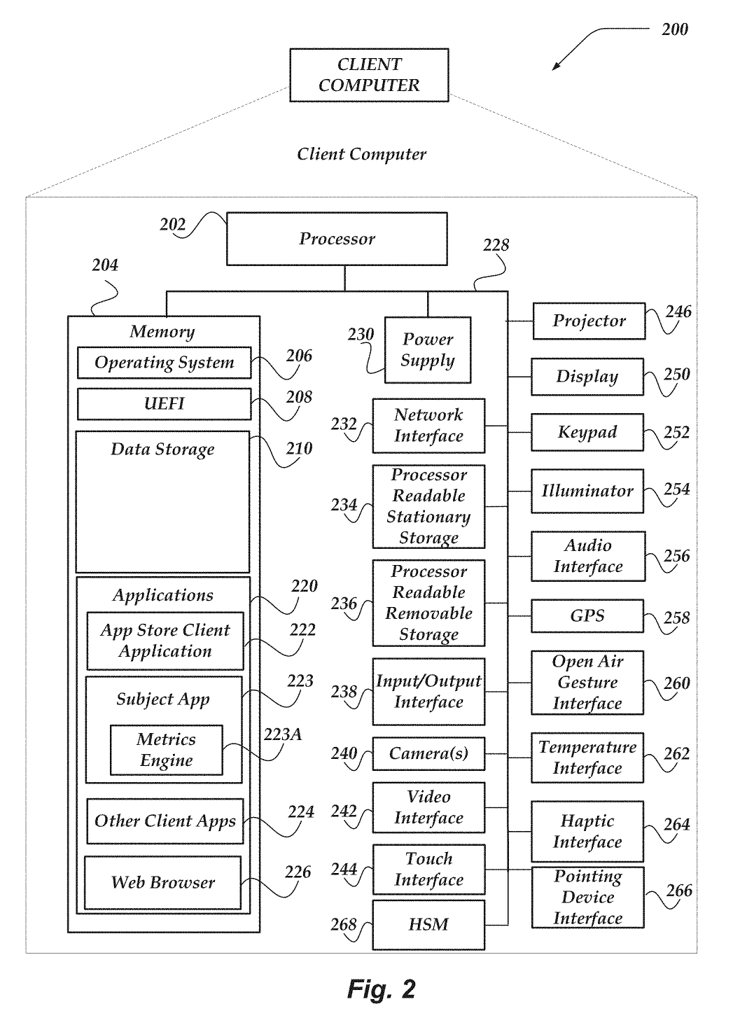

At least one embodiment of client computers 102-105 is described in more detail below in conjunction with FIG. 2. In one embodiment, at least some of client computers 102-105 may operate over one or more wired and/or wireless networks, such as networks 108, and/or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), JavaScript Object Notation (JSON), or the like, to display and send a message. In one embodiment, a user of the client computer may employ the browser application to perform various activities over a network (online). However, one or more other applications may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), one or more identifiers for content (IFAs), or other device identifier. Such information may be provided in a message comprised of one or more network packets, or the like, sent between other client computers, analytics server computer 116, content platform server computer 118, attribution platform server computer 120, or other computers. In some embodiments, the one or more processors of analytics server computer 116 may be arranged to perform one or more specific tasks for providing analytics associated with marketing services as described in detail below.

Client computers 102-105 may further be configured to include a client application that enables an end-user to log into an end-user account that may be managed by another computer, such as analytics server computer 116, content platform server computer 118, attribution platform server computer 120, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connections may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, analytics server computer 116, application store server computer 120, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

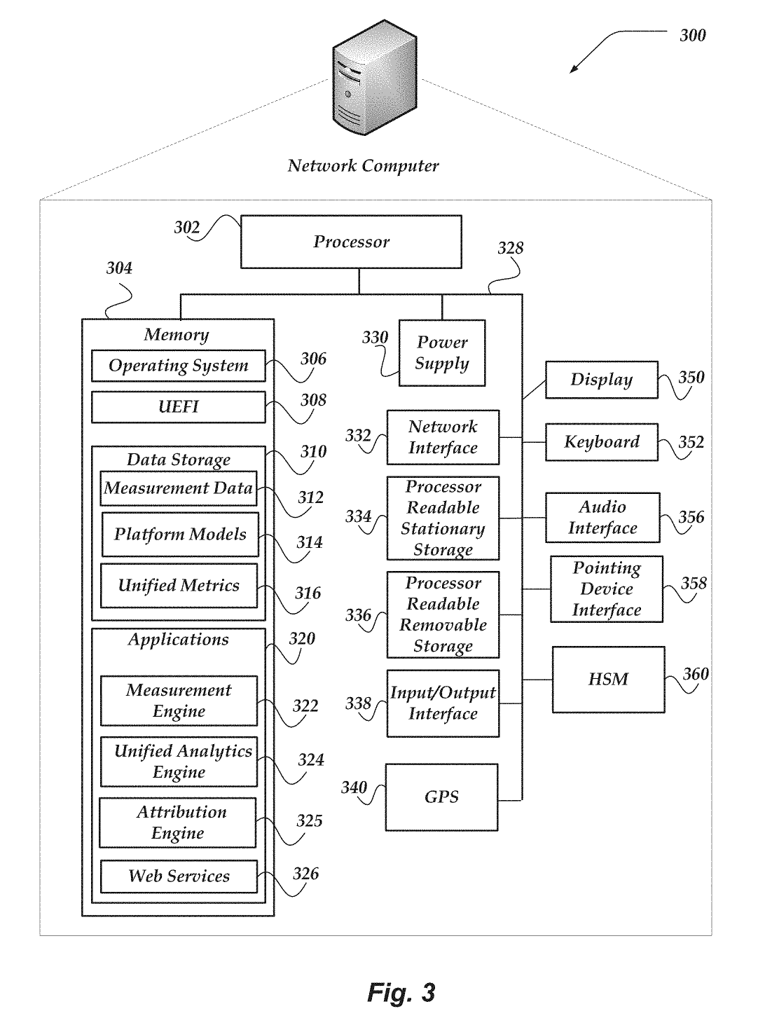

One embodiment of analytics server computer 116 is described in more detail below in conjunction with FIG. 3. Briefly, however, analytics server computer 116 includes virtually any network computer capable of executing one or more specialized engine to provide, manage, or report analytics associated with online marketing services.

Although FIG. 1 illustrates analytics server computer 116, content platform server computer 118, attribution platform server computer 120 are each illustrated as a single computer, the innovations and/or embodiments are not so limited. For example, one or more functions of analytics server computer 116, content platform server computer 118, attribution platform server computer 120, or the like, may be distributed across one or more distinct network computers. Moreover, analytics server computer 116, content platform server computer 118, attribution platform server computer 120 are not limited to a particular configuration such as the one shown in FIG. 1. Thus, in one embodiment, one or more of analytics server computer 116, content platform server computer 118, attribution platform server computer 120 may be implemented using a plurality of network computers. In other embodiments, server computers may operate as a plurality of network computers within a cluster architecture, a peer-to-peer architecture, or the like. Further, in at least one of the various embodiments, analytics server computer 116, content platform server computer 118, attribution platform server computer 120 may be implemented using one or more cloud instances in one or more cloud networks. Accordingly, these innovations and embodiments are not to be construed as being limited to a single environment, and other configurations, and architectures are also envisaged.

### Illustrative Client Computer

FIG. 2 shows one embodiment of client computer 200 that may include many more or less components than those shown. Client computer 200 may represent, for example, at least one embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring and/or maintaining an orientation of client computer 200.

Power supply 230 may provide power to client computer 200. In some cases, a rechargeable or non-rechargeable battery may be used to provide power. The power may also be provided by an external power source, such as an alternative current (AC) adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to event messages. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing and/or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, and/or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input and/or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS receiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In at least one embodiment, however, client computer 200 may, through other components, provide other information that may be employed to determine a physical location of the client computer, including for example, a Media Access Control (MAC) address, IP address, and the like.

Human interface components can be peripheral devices that are physically separate from client computer 200, allowing for remote input and/or output to client computer 200. For example, information routed as described here through human interface components such as display 250 or keypad 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store Unified Extensible Firmware Interface (UEFI) 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, and/or otherwise process instructions and data. Applications 220 may include, for example, application store client application 222, subject application 223, other client applications 224, web browser 226, or the like. Client computers may be arranged to exchange communications, such as, queries, searches, messages, notification messages, event messages, alerts, performance metrics, log data, application programing interface (API) calls, or the like, combination thereof, with application servers, network file system applications, analytics applications, or the like.

Subject application 223 represents one or more applications that may be installed on client computer 200 by a user, or other provider. In some cases, subject application 223 represents one or more applications provided by an application store server computer, such as, application store service computer 120. Subject application 223 represents an application that is arranged to capture user interaction information. Metrics engine 223A represent a module or library installed as part of subject application 223 that facilitates capturing user interaction information and providing it to an analytics server computer, such as, analytics server computer 116. In some embodiments, metrics engine 223A may be installed separately from subject application 223. Also, for some subject applications, metric engine 223A may be arranged to execute on client computer 200 separate from subject application 223.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include a hardware microcontroller instead of a CPU. In at least one embodiment, the microcontroller may directly execute its own embedded logic to perform actions and access its own internal memory and its own external Input and Output Interfaces (e.g., hardware pins and/or wireless transceivers) to perform actions, such as System On a Chip (SOC), or the like.

### Illustrative Network Computer

FIG. 3 shows one embodiment of network computer 300 that may be included in a system implementing at least one of the various embodiments. Network computer 300 may include many more or less components than those shown in FIG. 3. However, the components shown are sufficient to disclose an illustrative embodiment for practicing these innovations. Network computer 300 may represent, for example, one embodiment of one or more of analytics server computer 116, content platform server computer 118, or application store server computer 120 of FIG. 1.

As shown in the figure, network computer 300 includes a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. Display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect and/or measure data that is external to network computer 300.Human interface components can be physically separate from network computer 300, allowing for remote input and/or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In at least one embodiment, however, network computer 300 may, through other components, provide other information that may be employed to determine a physical location of the client computer, including for example, a Media Access Control (MAC) address, IP address, and the like.

Memory 304 may include Random Access Memory (RAM), Read-Only Memory (ROM), and/or other types of memory. Memory 304 illustrates an example of computer-readable storage media (devices) for storage of information such as computer-readable instructions, data structures, program modules or other data. Memory 304 stores a Unified Extensible Firmware Interface (UEFI) 308 for controlling low-level operation of network computer 300. The memory also stores an operating system 306 for controlling the operation of network computer 300. It will be appreciated that this component may include a general-purpose operating system such as a version of UNIX, or LINUX™, or a specialized operating system such as Microsoft Corporation's Windows ® operating system, or the Apple Corporation's IOS® operating system. The operating system may include, or interface with a Java virtual machine module that enables control of hardware components and/or operating system operations via Java application programs. Likewise, other runtime environments may be included.

Memory 304 may further include one or more data storage 310, which can be utilized by network computer 300 to store, among other things, applications 320 and/or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by one or more processors, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, measurement data 312, platform models 314, unified metrics 316, or the like. measurement data 312 may be one or more data stores that include one or more records, logs, events, file system entries, databases, or the like, associated with analytics. In some embodiments, data storage 310 may also include platform models 314. Platform models 314 may include one or more models for integrating with one or more content platforms. In some embodiments, unified metrics 316 may include metrics associated with one or more content platforms and one or more attribution platforms merged into a unified model, or the like.

Applications 320 may include computer executable instructions which, when executed by network computer 300, transmit, receive, and/or otherwise process messages (e.g., SMS, Multimedia Messaging Service (MMS), Instant Message (IM), email, and/or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, web services 326, and so forth. Applications 320 may include measurement engine 322, unified analytics engine 324, attribution engine 325, or the like, that may be arranged to perform actions further described below. In at least one of the various embodiments, one or more of the applications may be implemented as modules and/or components of another application. Further, in at least one of the various embodiments, applications may be implemented as operating system extensions, modules, plugins, or the like.

Furthermore, in at least one of the various embodiments, measurement engine 322, unified analytics engine 324, attribution engine 325, or the like, may be operative in a cloud-based computing environment. In at least one of the various embodiments, these applications, and others, may be executing within virtual machines and/or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines and/or virtual servers dedicated to measurement engine 322, unified analytics engine 324, attribution engine 325, or the like, may be provisioned and de-commissioned automatically.

Also, in at least one of the various embodiments, measurement engine 322, unified analytics engine 324, attribution engine 325, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing and/or using security/cryptographic information such as, keys, digital certificates, passwords, passphrases, two-factor authentication information, or the like. In some embodiments, hardware security module may be employ to support one or more standard public key infrastructures (PKI), and may be employed to generate, manage, and/or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), the network computer may include one or more embedded logic hardware devices instead of one or more CPUs, such as, an Application Specific Integrated Circuits (ASICs), Field Programmable Gate Arrays (FPGAs), Programmable Array Logics (PALs), or the like, or combination thereof. The embedded logic hardware devices may directly execute embedded logic to perform actions. Also, in one or more embodiments (not shown in the figures), the network computer may include one or more hardware microcontrollers instead of a Central Processing Unit (CPU). In at least one embodiment, the one or more microcontrollers may directly execute their own embedded logic to perform actions and access their own internal memory and their own external Input and Output Interfaces (e.g., hardware pins and/or wireless transceivers) to perform actions, such as System On a Chip (SOC), or the like.

### Illustrative Logical System Architecture

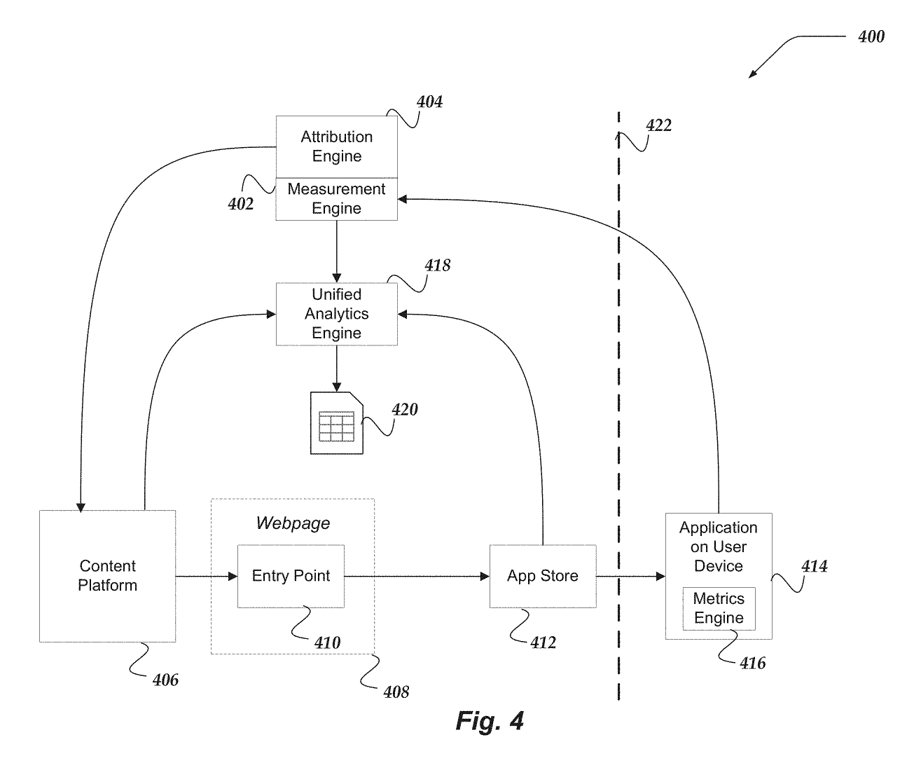

FIG. 4 illustrates a logical schematic of analytics system 400 in accordance with at least one of the various embodiments. In at least one of the various embodiments, analytics system 400 may be arranged to include measurement engine 402, attribution engine 404, and unified analytics engine 418. Also, in at least one of the various embodiments, analytics system 400 may include entry point 410, application store 412, application 414 (including metrics engine 416), analytics report 420, or the like. Also, in this illustration, boundary 422 represents that the installed application. Application 414 is separated from app store 412 by virtue of being installed on a user's client computer.

In at least one of the various embodiments, analytics system 400 may be arranged to monitor and track user interaction with various applications that may be provided to one or more of their client computers, including mobile computers (e.g., smart phones). In some embodiments, analytics system 400 may collect information and/or metrics that enable stakeholders, such as, application developers, content distributers, content platforms, or the like, to report on the effectiveness (e.g., return on investment) of different content distributions, content methods, or the like.

In at least one of the various embodiments, application developers, content distributors, or the like, may distribute their products on one or more different application online stores. In some cases, these online application stores may be operated by other companies/organizations that provided searchable catalogs that consumers may use for downloading and/or purchasing applications.

Also, in some embodiments, online application stores (e.g., app stores) may provide an application store page (e.g. landing page) that describes the offered application and may provide various features such as consumer reviews, screen shots, videos, or the like. Also, the app store page often provides user-interface controls enabling a consumer to buy and/or download the offered application to one or more of their computers, including client computers, mobile computers, smartphones, or the like.

In at least one of the various embodiments, application store 412 may be operated by a third party that is not associated with analytics system 400. In some embodiments, application store 412 may be a digital marketplace that may be authorized by one or more other organization for selling/delivering applications, media, or the like, to consumers. For example, application store 412 may represent the Apple App Store, Google Play (e.g., Google's digital marketplace). Microsoft's Windows Store, Amazon's Amazon Appstore, or the like. Accordingly, in many embodiments, application stores, such as, application store 412 may have limited or restricted integration features and may cutoff the tracking and monitoring done by measurement engine 402 and/or content platform 406. In some embodiments, application store 412 may be arranged to communicate some purchase information to unified analytics engine 418 indicating that the user has obtained the offered application. The type of information that may be provided by application store 412 to unified analytics engine 418 may be limited depending on the policy of the application store owners/operators. Also, in some embodiments, the catalog of offerings presented by application store 412 may be stored in a cloud based environment. Accordingly, in some embodiments, the user may execute an application store client on their client computer that enables the user to select, purchase, download, and install the offered application on the client computer (e.g., smart phone, desktop computer, tablet computer, or the like).

In at least one of the various embodiments, once the offered application is downloaded onto the user's client computer, application 414 may be arranged to communicate certain user interactions to measurement engine 402.

In at least one of the various embodiments, depending on the available information, a unified analytics engine, such as unified analytics engine 418 may be enabled to provide a unified representation of information provided by various sources, such as attribution engine 404, measurement engine 402, content platform 406, application 414, or the like, or combination thereof.

In at least one of the various embodiments, installed application 414 may include a metrics engine (e.g., metrics engine 223A, metrics engine 416, or the like) that may be arranged to communicate one or more events to measurement engine 402. In at least one of the various embodiments, events may include information for associating the event information with the source device.

In some embodiments, the particular information used for associating the client computer with the event may depend on the particular client computer being used. In some embodiments, different operating systems of client computers may dictate the type of information and/or its availability to its metrics engine. For example, some client computer operating systems may limit or otherwise restrict the type of information that may be gathered by metrics engine 416 for providing to measurement engine 402. Further, some operating systems may enable the user to modify the information sharing permissions of their client computer and/or for each application.

In at least one of the various embodiments, metrics engines, such as metrics engine 416 may be integrated into client applications using libraries, modules, plug-ins, or the like, that are compiled in the application. Further, in some embodiments, metrics engines may be installed on the client computers separate from application 414. For example, in some embodiments, metrics engine 414 may be installed as a separate application and/or included/integrated with the client computer operating system.

In some embodiments, metrics engines may provide APIs that enable application developers to communicate various events to a measurement engine. Accordingly, client application developers may arrange their applications to communicate events that represent users' activity during their interactions with the installed application.

In at least one of the various embodiments, metrics engine 416 may provide one or more interfaces that enable applications to provide events and communicate them to measurement engine 402. In at least one of the various embodiments, applications may be arranged to provide custom event labels, tags, description, or the like, that may be relevant to the application. Also, in some embodiments, one or more standard fields, such as, timestamps, source computer information (e.g., OS version, device type, device model, or the like), one or more device identifiers, or the like. In at least one of the various embodiments, privacy policies and/or privacy facilities of client computers and/or client computer operations may restrict the type of identifying information that may be included in an event. Is some embodiments, client computer vendors (or operation system developers) provide special identifiers that are allowed for use by vendors/content providers for tracking application usages/interactions on client computers rather than unique identifiers that may be hardwired to a user's client computer, such as MAC addresses, MIEN, or the like. For example, in some embodiments, client computer operating system IOS enables applications to use a provided Identifier for Advertisers (IFA) and/or an Identifier for Vendors (IFV) to identify client computers. Likewise, the Android operating system provides Google Advertising ID (AID). One of ordinary skill in the art will appreciate that various operating systems may be arranged to provide a variety of different types of identifiers that may be included in an event. In some embodiments, the metrics engine may be arranged to default to using the appropriate identifier for a given client computer. In other embodiments, application developers may be enabled/required to provide the appropriate identifiers to the metrics engine.

Examples of device identifiers include, but are not limited to, a media access control (“MAC”) Address, an International Mobile Station Equipment Identity (WEI″), a Mobile

Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), a Google AdID, combinations thereof, and the like. By way of a non-limiting example, the IMEI may be an Android IMEI. By way of another non-limiting example, the MEID may be an Android MEID. Another example of a device identifier is a value assigned to the end user client computer by system 400.

In some embodiments, other information associated with one of a client computer may also be used as device identifying information, and may include an Internet Protocol (IP) Address, browser information (e.g., browser type, browser version, a cookie, etc.), or the like, or combinations thereof In some embodiments, this other information may be usable to identify a user's client computer, though the other information may be less reliable.

In at least one of the various embodiments, if an application is installed on a client computer, the metrics engine (installed on the same client computer) may communicate one or more events that may be associated with the installation to the measurement engine. Also, applications may be arranged to employ metrics engines to send events each time they are launched on a client computer. Accordingly, in some embodiments, identifiers included in the events may be employed to correlate actions occurring on the installed application with attribution information and/or content platform information.

In one or more of the various embodiments, attribution engine 404 may be arranged to enable users to design content and/or online content distribution plans associated with one or more applications they may be offering. Accordingly, in one or more of the various embodiments, attribution engine 404 may be arranged to provide an entry point, such as entry point 410 that corresponds to the content distribution. Alternatively, in one or more of the various embodiments, the attribution engine may be provide an entry point provided an external service. In this case, the entry point may be shared with content platform 406 and attribution engine 404.

In one or more of the various embodiments, entry points, such as entry point 410 may be URLs, links, or the like, associated with a content distribution. In some embodiments, entry point 410 may be an URL hosted in a web page, such as web page 408. For example, in some embodiments, entry point 410 may be an image or other media for display in a web page. Accordingly, in this example, if a user clicks (or otherwise selects) entry point 410 they may be directed to a landing page in app store 412 that is associated with application 414.

In one or more of the various embodiments, at the landing page the user may review information about the application (e.g., application 414) that is associated with entry point 410 and accept or decline an invitation to install application 414 on user device 414. Accordingly, in one or more of the various embodiments, app store 412 may be arranged to provide app store metrics associated with entry point 410 to unified analytic engine 418. App store metrics may include various metrics, such as, user purchases, user downloads, or the like, for a given application.

In at least one of the various embodiments, entry point 410 may be associated with tag information for identifying the offered applications, the content distribution (e.g., distribution identifier), the source of the entry point, user device information, user information, or the like. For example, in some embodiments, if the entry point is a URL there may be one or more values appended and/or included in the Unified Resource Locator (URL) that may be used to identify/track the user and/or other information associated with the distribution. For example, entry point 410 may represent one or more URL's provided by online content, emails, SMS texts, or the like. In some embodiments, entry point 410 may be provided by an intermediary, such as, wireless carriers, web services, content platforms, content distributers, or the like. For example, entry point 410 may be a link or reference associated with content for a particular application.

In one or more of the various embodiments, content platform 406 may arranged to record/track user interactions with distributed content associated with an entry point. Accordingly, content platform 406 may be arranged to provide a user reports on how many times users viewed the entry points or its associated content and/or how many times a user interacted with the entry point (e.g., clicked on the content).

In one or more of the various embodiments, unified analytics engine 418 may be arranged to automatically collect various metrics, such as, app store metrics from app store 412, content metrics from content platform 418, or the like. In some embodiments, content platforms may provide one or more APIs that enable the automatic collection of content metrics. Accordingly, collection of content platform metrics may be simplified. However, different content platforms may use different formats to represent the same or similar metrics. Also, in one or more of the various embodiments, since content platforms may be separated from the app store and/or the installed application, content metrics may be limited to information related to the entry point or content associated with the entry point.

Likewise, in one or more of the various embodiments, attribution engines, such as attribution engine 404 may be arranged to provide attribution metrics that may be automatically collected. However, in some embodiments, attribution metrics provided by attribution engines or different attribution platforms (not shown) may be formatted inconsistently and/or differently than content metrics.

In one or more of the various embodiments, unified analytics engine 418 may be arranged to collect content metrics and attribution metrics and transform them into unified analytic metrics that encompass both content metrics and attribution metrics. Also, in one or more of the various embodiments, unified analytics engines may be arranged to provide additional metrics based on content metrics and/or attribution metrics.

In at least one of the various embodiments, measurement engines, such as unified analytics engine 420 may be arranged to provide one or more reports, such as, report 420 that enable content distributers, content providers, application developers, or the like, to analyze the performance of one or more content distributions. In some embodiments, report 420 may be generated based on one or more queries provided by a user. In other embodiments, report 420 may include all events associated with one or more applications. In some embodiments, report 420 may be provided to other external applications that provide visualization tools, analytics analysis, or the like. Likewise, in some embodiments, unified analytics engines may provide one or more visualization tools and/or one or more analysis tools for analyzing collected event information. Also, in some embodiments, report 420 may represent an interactive graphical user-interface that enables users to perform analysis in real-time or near real-time using queries, reports, graphs, filters, or the like.

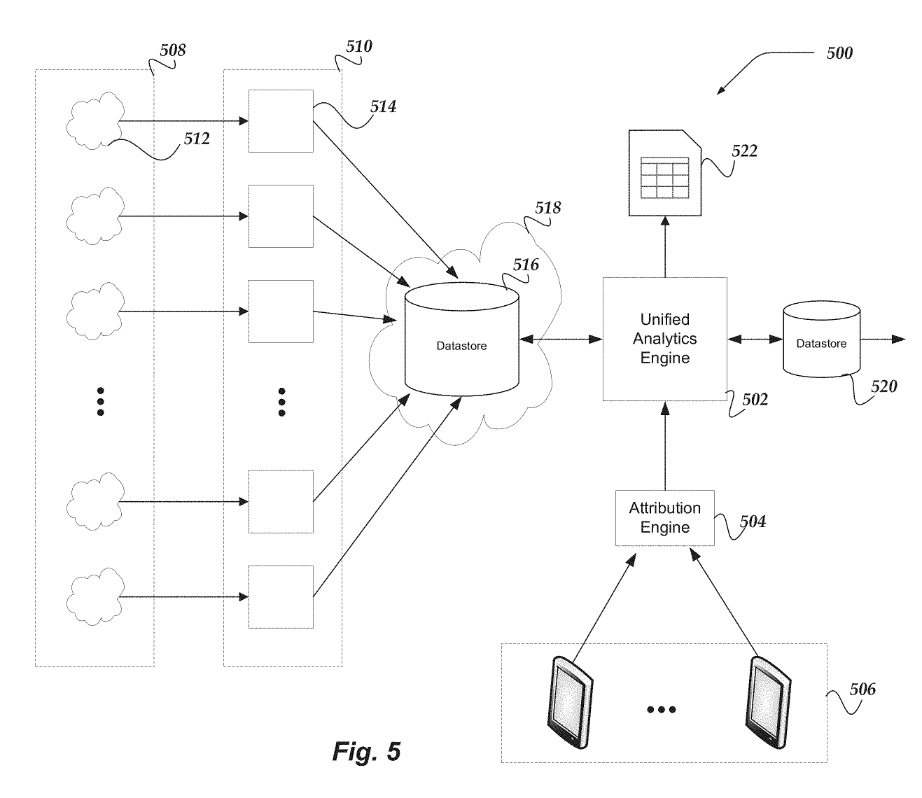

FIG. 5 illustrates a logical schematic of system 500 for unified analytics for measuring user interaction in accordance with one or more of the various embodiments. In one or more of the various embodiments, a unified analytics engine, such as unified analytics engine 502 may be arranged to collect attribution data from one or more attribution engines, such as attribution engine 504. In some embodiments, attribution engine 504 may be arranged to provide attribution data based on various events provided by various applications running on client computers 506. In some embodiments, as discussed above, one or more client computers, such as, client computer 506 may be running one or more applications that may include metrics engines.

In one or more of the various embodiments, one or more content platforms, such as content platform 508 may be collecting information related to the distributed content and user interactions associated with various entry points. Accordingly, one or more connector agents, such as connector agents 510 may be arranged to collect this information from the one or more content platforms. In some cases, an application developer may employ multiple content platforms to distribute content that may be associated with their applications. In other cases, an application developer may use just one content platform.

In one or more of the various embodiments, each content platform may be associated with a connector agent. In this example, content platform 512 is associated with connector agent 514. In some embodiments, connector 514 may be arranged to collect content information from content platform 512. Accordingly, connector 512 may be specialized such that it may use the APIs particular to content platform 512 which may be different than other content platforms. Likewise, in one or more of the various embodiments, other connector agents in connector agents 510 may be similarly specialized to the enable them to use other APIs that may be provided by other content platforms.

In one or more of the various embodiments, connector agents 510 may be arranged to collect content platform data for storing in data store 516. Data store 516 may be a persistent data storage facility accessible by connector agents 510 and unified analytics engine 502. In some embodiments, data store 516 may be located in a cloud-based computing environment, such as cloud-based computing environment 518. In other embodiments, data store 516 may be located at one or more data centers, or other hosting environments that may be reachable over a network by the connector agents and the unified analytics engine.

In one or more of the various embodiments, since the connector agents may be arranged to communicate to the content platforms over a network, in some cases, the availability of the network or lack thereof may interrupt or delay one or more connector agents from collecting the data. Accordingly, in one or more of the various embodiments, if the quality of the network communication to with the content platforms is below one or more threshold values (e.g., throughput, packet loss, latency, bandwidth, dropped connections, or the like), the connector agent may be arranged to postpone data collection until the quality of the network communication with the content platform is restored. In some embodiments, if the network communication with the content platforms is determined to be unreliable or ineffective, one or more connector agents may be arranged to select from one or more backup or alternative network configurations. Thus, in one or more of the various embodiments, if a connection agent is unable to establish a connection (of satisfactory quality) with a content platform, the connection agent may try different network configurations that may produce a satisfactory connection. For example, in some embodiments, a connection agent may be arranged to try one or more different DNS servers, one or more different network routes, one or more different hostnames or IP addresses for the content platform, or the like, or combination thereof. In one or more of the various embodiments, alternative network configurations may be stored in configuration information accessible by the connection agents, such as, configuration files, databases, or the like.

In some embodiments, if a connection agent is unable to establish a network connection with a content platform, it may communicate a message to another connector agent to begin collecting the data. Accordingly, in one or more of the various embodiments, a connection agent located in one geographic area may hand off the data collection to another connection agent located in an another geographic area.

In one or more of the various embodiments, connector agents 510 may be arranged to map a portion of the information provided by the content platform to a data model that may be consistent with the unified analytics engine. Accordingly, in some embodiments, content data organized using disparate data models used by separate content platforms may be transformed and normalized to conform to a data model consistent with the unified analytics engine.

In one or more of the various embodiments, unified analytics engine 502 may be arranged to pull the transformed content platform data from data store 516. Also, in one or more of the various embodiments, unified analytics engine 502 may be arranged to pull attribution platform data from attribution engine 504. Accordingly, in some embodiments, the unified analytics engine may be arranged to merge the data (content data) from the content platforms with data (attribution data) provided by the attribution platform(s).

In one or more of the various embodiments, the unified analytics engine may be arranged to take the data from the content platforms and the attribution platform and transform or normalize it to conform to a unified model that represents how users are interacting with content provided for one or more distributions.

In one or more of the various embodiments, there may be several attribution platforms. In these embodiments, connector agents may be arranged for each attribution platform similar as described for the content platforms.

In one or more of the various embodiments, unified analytics engines, such as unified analytics engine 502 may be arranged to store the unified metrics in another data store, such as data store 520. Accordingly, in some embodiments, authorized users may be enabled to access the unified metrics and generate their own reports and/or analysis based on the unified metrics.

Also, in one or more of the various embodiments, unified analytics engines, such as unified analytics engine 502 may be arranged to provide one or more reports based on the unified metrics, such as report 522. In some embodiments, report 522 may be an interactive user-interface. In other embodiments, report 522 may be a static document.

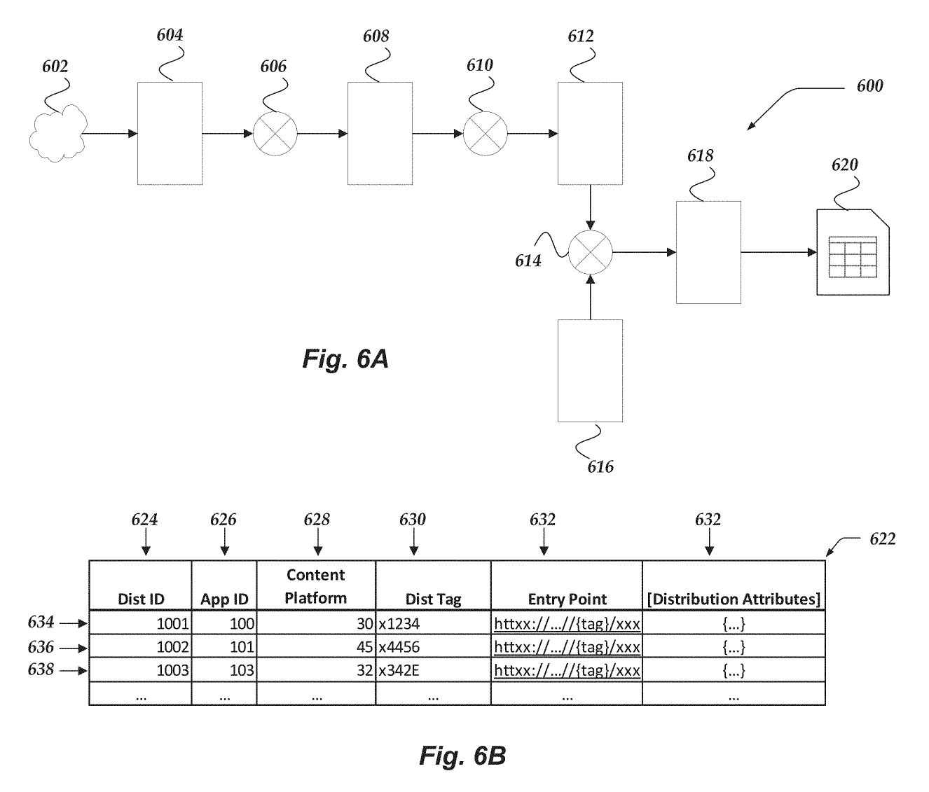

FIG. 6A represents a logical schematic of system 600 for producing reports based on unified metrics in accordance with one or more of the various embodiments. System 600 shows how information provided from a content platform may be processed to produce reports based on unified metrics. In one or more of the various embodiments, a content platform, such as content platform 602 may provide raw content platform data 604. The raw content platform data may be transformed by a connector agent, such as connector agent 606 into normalized content platform data 608. As described above, the normalized content platform data may be stored at an intermediate data store. In one or more of the various embodiments, a unified analytics engine may be arranged to collect normalized content platform data 608 and transform it into unified content data 612.

In one or more of the various embodiments, the unified analytics engine may be arranged to execute a merging process, such as merging process 614 that collects attribution platform data 616 and merges it with unified content data 612 to produce unified metrics 618. Accordingly, in one or more of the various embodiments, unified metrics 618 may be provided or made available for one or more reports, such as report 620.

FIG. 6B represents a logical schematic of data object 622 for associating content distributions with applications in accordance with one or more of the various embodiments. In one or more of the various embodiments, an attribution engine, or in some embodiments, a unified metrics engine may be arranged to associate content distributions with applications. Accordingly, in one or more of the various embodiments, content activity included in the content platform data may be associated with one or more applications. Likewise, in one or more of the various embodiments, attribution data may be associated with an application.

In one or more of the various embodiments, data object 622 may be arranged to include various fields that associate distributions, applications, or the like, such as, distribution identifier field 624, application identifier field 626, distribution tag field 630, entry point field 632, one or more other distribution attributes (e.g., field 632 representing one or more other fields), or the like.

In one or more of the various embodiments, distribution identifier 624 may be an identifier representing a particular distribution. Also, in one or more of the various embodiments, content platform identifier field 628 may hold values corresponding to particular content platforms. In one or more of the various embodiments, distribution tag field 630 may be arranged to hold identifiers corresponding to a distribution that may be provided to a content platform. In some embodiments, having a separate distribution tag fields enables the tags to be formulated such that they conform to one or more tag formats that may be required by a content platform. Distribution tag values may be provided to content platforms to enable content activity to be grouped or correlated with a given distribution. In some embodiments, distribution identifier field 624 and distribution tag field 630 may serve the same purpose. In such embodiments, data object 622 may be arranged to use one field for both distribution identifiers and distribution tags.

In one or more of the various embodiments, data object 622 may include entry point field 632 that hold an entry point (or a reference to an entry point) for the particular distribution. In some embodiments, the entry point value in a field like entry point field 632 may be a portion of the entry point, the complete entry point, or a template for an entry point (with placeholders for tagging/id values that may be inserted). In one or more of the various embodiments, application identifier field 626 hold values that may be used to identify a particular application. In one or more of the various embodiments, each application may be assigned an identifier that its metrics engine includes in event information that the application provides to the attribution engines.

Further, in one or more of the various embodiments, additional distribution attributes, represent here by fields 632, may include one or more addition fields that include values describing or representing various characteristics of a distribution. In some embodiments, additional fields may include: date ranges indicating the time periods the distribution may be active; various distribution features that define the operation or application of the distribution (e.g., target content networks, key words, key terms, geographic targets, or the like); descriptions; titles; or the like. Note, in some embodiments, operational details of a distribution may be stored in other data structures or even stored on other services. In this example, fields 632 represents that additional fields may be included in data object 622 depending on the embodiment.

In one or more of the various embodiments, application identifier field 626 may be arranged to hold values that correspond to a particular application. Accordingly, in one or more of the various embodiments, the application identifier value may be known or otherwise provided to the application developer. The application developers may arrange their applications to use the application identifier in their applications to associate metrics with the application. For example, the provided application identifier may be included in the events provided by the client metrics engine to the attribution engine.

In one or more of the various embodiments, data object 622 may be arranged to use the distribution tag and the application identifier to associate content data of a particular distribution with attribution data provided by a particular application.

In this example, in one or more of the various embodiments, row 634 shows how distribution ID “1001” may be associated with application ID “100”. Likewise, in this example, row 634 shows how distribution ID “1002” may be associated with application ID “101”. Further, in this example, row 636 shows how distribution ID “1003” may also be associated with application ID “101.”

One of ordinary skill in the art will appreciate that data object 622 may be arranged to include different fields, fields in different order, different data-types, and so on, without departing from the innovations disclosed herein. Likewise, for brevity and clarity, data object 622 is represented using a table/tabular format. One of ordinary skill in the art will appreciate that data objects such as data object 622 may be arranged differently using different formats, data structures, objects, or the like, without departing from the scope of these innovations.

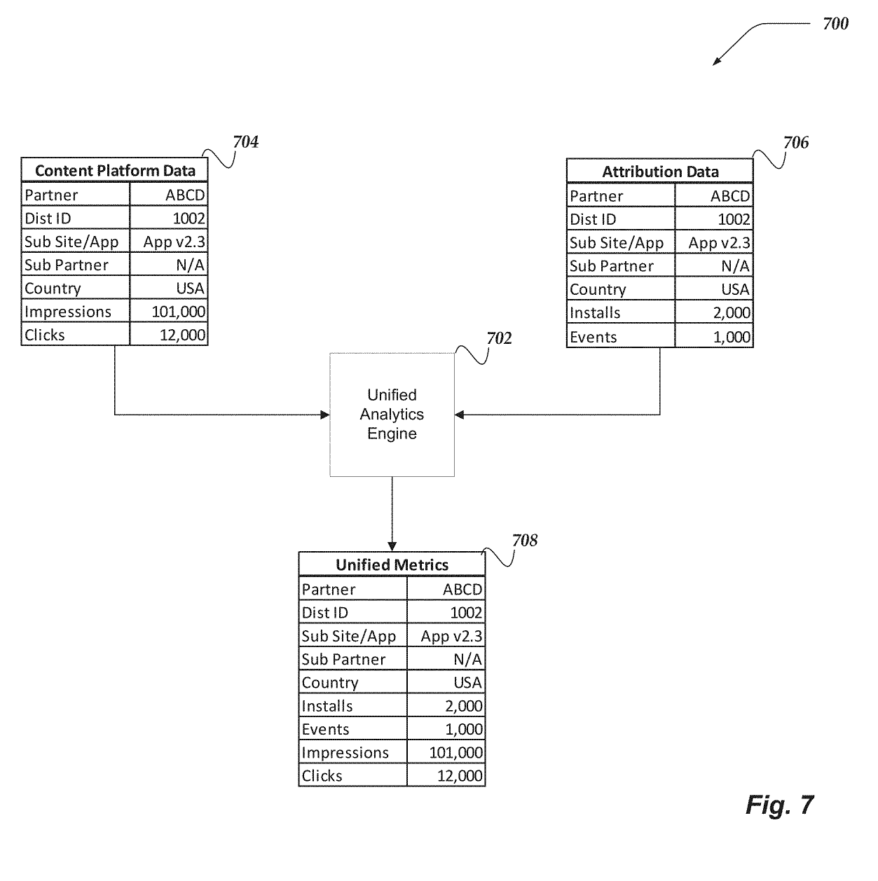

FIG. 7 represents a logical schematic of system 700 for producing unified metrics in accordance with one or more of the various embodiments. A unified analytics engine, such as unified analytics engine 702 may be arranged to combine normalized content platform data, such as normalized content platform data 704 with normalized attribution platform data, such as normalized attribution platform data 706 to provide unified metrics, such as unified metrics 708. Accordingly, in one or more of the various embodiments, metrics from disparate systems may be transformed and presented using a unified model.

In one or more of the various embodiments, the unified analytics engine may have access to information provided by the attribution engines or attribution platforms that may be unavailable to the content platforms. Likewise, the unified analytics engine may also have access information that may be unavailable to the attribution platforms.

Accordingly, in some embodiments, the unified metrics may be arranged to include information (e.g., fields or attributes) that is not provided by the content platforms or the attributions engines. Further, in one or more of the various embodiments, the unified metrics may be arranged to include one or more fields that may be derived from a combination of one or more fields of the content platform data or one or more fields of the attribution platform data.

### Generalized Operations

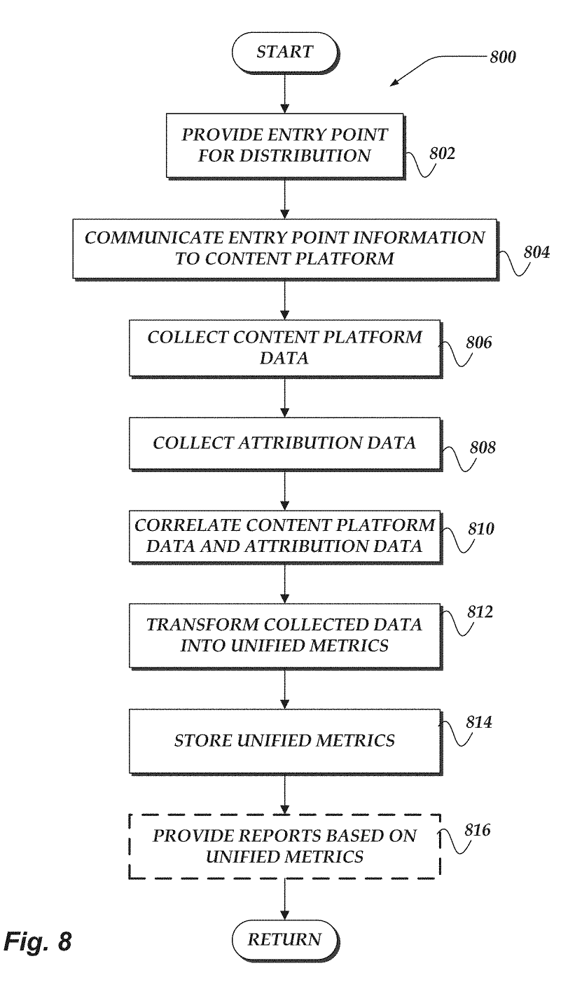

FIGS. 8-11 represent the generalized operations for unified metrics for measuring user interactions in accordance with at least one of the various embodiments. In at least one of the various embodiments, processes 800, 900, 1000, or 1100 described in conjunction with FIGS. 8-11 may be implemented by and/or executed by one or more processors on a single network computer, such as network computer 300 of FIG. 3. In other embodiments, these processes, or portions thereof, may be implemented by and/or executed on a plurality of network computers, such as network computer 300 of FIG. 3. In yet other embodiments, these processes, or portions thereof, may be implemented by and/or executed on one or more virtualized computers, such as, those in a cloud-based environment. However, embodiments are not so limited and various combinations of network computers, client computers, or the like may be utilized. Further, in at least one of the various embodiments, the processes described in conjunction with FIGS. 8-11 may be used for unified metrics for measuring user interactions in accordance with at least one of the various embodiments and/or architectures such as those described in conjunction with FIGS. 4-7. Further, in at least one of the various embodiments, some or all of the actions performed by processes 800, 900, 1000, or 1100 may be executed in part by measurement engine 322, unified analytics engine 324, attribution engine 325, or the like, running on one or more processors of one or more network computers.

FIG. 8 illustrates an overview flowchart for process 800 for unified metrics for measuring user interactions in accordance with at least one of the various embodiments. After a start block, at block 802, in one or more of the various embodiments, an entry point may be provided for a distribution. As described above, users preparing to conduct a content distribution may create or obtain one or more entry points that correspond to the content distribution for one or more applications. In some embodiments, the entry point may be provided by a content distributor or other service provider. In other embodiments, application owners may provide the entry point information. For example, in some embodiments, a content distributor may provide the entry point as part of a comprehensive content distribution. In other cases, an application developer may provide the entry point.

In one or more of the various embodiments, the entry point may be a URL, or other type of reference that may be presented to potential customers. Accordingly, In some embodiments, if users interact with the entry point (e.g., clicking a link or URL) they may be directed to a facility or service where they may provide the application, such as an online application store, mobile application store, or the like.

In one or more of the various embodiments, the entry point may be associated with a distribution identifier and registered with an attribution engine, such as attribution engine 325. In one or more of the various embodiments, the distribution identifier may be associated with the application developer/distributor and the particular content distribution for the application.

In one or more of the various embodiments, the distribution identifier may be provided by an content distribution service that may be providing the entry point. In other embodiments, the user may declare an identifier. Also, in some embodiments, the distribution identifier may be provided by another service, such as a content platform that may distribute the entry point to potential customers. Nevertheless, entry points and distribution identifiers may be arranged to be compatible with content platforms that are tasked to distribute the entry point.

At block 804, in one or more of the various embodiments, the entry point information may be communicated to a content platform. In one or more of the various embodiments, the attribution engine may be arranged communicate the entry point information to one or more content platforms. In some embodiments, a user may input the entry point information into a user-interface provided by the content platforms. Alternatively, in one or more of the various embodiments, the attribution engine may communicate the entry point information (e.g., including distribution identifiers, distribution parameters, or the like) to the content platforms over a network using API.

In one or more of the various embodiments, the developer/distributor of the application may elect to employ more than one content platform to distribute content associated with the application. Accordingly, in one or more of the various embodiments, additional entry points compatible with each content platform may be provided and associated with the distribution and/or the application. For example, a one content platform may specialize in webpage hosted content, while another content platform may be valued for placing contents in search engine results, and still another may specialize in providing video content. Accordingly, in this example, each content platform may require different entry point information that may be uniquely formatted.

Further, in some embodiments, entry point information may include media assets, such as content or media that the content platform may associate with the entry point as it is distributed to potential customers. The particular media requirements or formatting requirements may be published by each content platform.

In one or more of the various embodiments, the content platforms may distribute the entry point to users that may be interest in the application. Subsequently, the content platform may begin collecting user interaction information associated with the entry point and any associated content.

At block 806, in one or more of the various embodiments, content platform data may be collected. As described above, one or more connector agents may be directly in communication (over a network) with individual content platforms. Accordingly, in one or more of the various embodiments, the unified analytics engine may be arranged to collect the content platform data from a central repository of data populated by the one or more connector agents.

In one or more of the various embodiments, since the connector agents may be arranged to communicate to the content platforms over a network, in some cases, the availability of the network or lack thereof may interrupt or delay one or more connector agents from collecting the data. Accordingly, in one or more of the various embodiments, if the quality of the network communication to with the content platforms is below one or more threshold values (e.g., throughput, packet loss, latency, bandwidth, dropped connections, or the like), the connector agent may be arranged to postpone data collection until the quality of the network communication with the content platform is restored. In some embodiments, if the network communication with the content platforms is determined to be unreliable or ineffective, one or more connector agents may be arranged to select from one or more backup or alternative network configurations. Thus, in one or more of the various embodiments, if a connection agent is having problems establishing a connection (of satisfactory quality) with a content platform, the connection agent may try different network configurations that may result in a satisfactory connection. For example, in some embodiments, a connection agent may be arranged to try one or more different DNS servers, one or more different network routes, one or more different hostnames or IP addresses for the content platform, or the like, or combination thereof. In one or more of the various embodiments, that alternative network configuration may be stored in configuration information accessible by the connection agents, such as, configuration files, databases, or the like.

In some embodiments, if a connection agent is unable to establish a network connection with a content platform, it may communicate a message to another connector agent to begin collecting the data. Accordingly, in one or more of the various embodiments, a connection agent located in one geographic area may hand off the data collection to another connection agent location in an alternative geographic area.

At block 808, in one or more of the various embodiments, attribution platform data may be collected. In one or more of the various embodiments, the attribution engine may be arranged to collect attribution data associated with the application. For example, the attribution engine may collect user interactions, such as installations, in-application purchases, launching/running the application, app feature interaction, or the like. As described above, the particular user interaction events captured by the attribution engine may vary depending on the goals of the application developer. Accordingly, in one or more of the various embodiments, application developers may arrange their applications to provide one or more events to the attribution engine using an API provided by the attribution platform provider.

In one or more of the various embodiments, one or more attribution engines may be part of the same analytics platform that may be operating the unified analytics engine. Accordingly, in some embodiments, the attribution data may be directly available to the unified analytics engine on demand.

Alternatively, in one or more of the various embodiments, one or more attribution engines may be operated by as separate services by one or more attribution platforms. Accordingly, in some embodiments, attribution data may be initially collected by one or more connector agents arranged to communicate directly with the separate attribution platforms. Thus, in some embodiments, some or all the attribution data may be collected from the attribution platforms by connector agents that store the data in a repository that may be accessed by the analytics platform to provide to a unified analytics engine, such as unified analytics engine 324

At block 810, in one or more of the various embodiments, the collected content data and the collected attribution data may be correlated together and associated with a content distribution. In one or more of the various embodiments, an application identifier associated with the attribution data may be used as the main key or identifier that is associated with collected content data. In some embodiments, if the application identifier is unavailable, a distribution identifier, or other identifiers or combinations of identifiers associated with the content data may be employed to perform the correlation.

At block 812, in one or more of the various embodiments, the collected data may be transformed into unified metrics. In one or more of the various embodiments, the unified analytics engine may be arranged to provide unified metrics for the distributions based on the collected content data and the collected attribution data. As described above, the unified metrics may include user interaction information, content distribution costs, application installations, application interactions, or the like, or combination thereof, correlated based on the distribution identifier and the application identifier.

At block 814, in one or more of the various embodiments, the unified metrics may be stored. In one or more of the various embodiments, the unified analytics engine may be arranged to store the unified metrics in a data store using a format that enables access by the owners/promoters. Accordingly, in some embodiments, they may obtain the unified metrics and employ them to analyze how users have interacted with the distributed content.

At block 816, in one or more of the various embodiments, optionally, one or more reports based on the unified metrics may be provided. In one or more of the various embodiments, the unified metrics engine may be arranged provide reports directly to the developers/distributors of the application. For example, in one or more of the various embodiments, the unified analytics engine may be arranged to provide a graphical user-interface that displays the unified metrics in various formats such as graphs, charts, lists, or the like, or combination thereof. Next, control may be returned to a calling process.

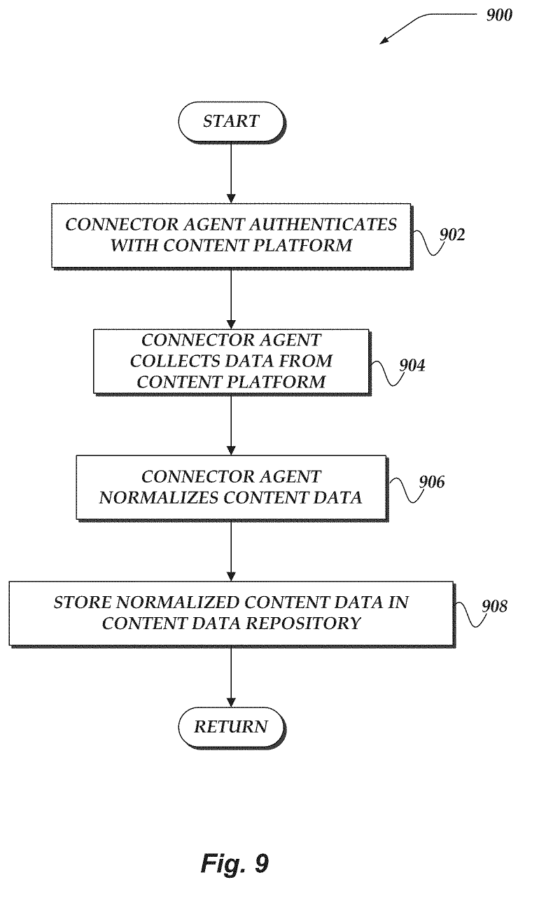

FIG. 9 illustrates an overview flowchart for process 900 that collects content data from content platforms in accordance with at least one of the various embodiments. After a start block, at block 902, in one or more of the various embodiments, a connector agent may authenticate with a content platform. In one or more of the various embodiments, each content platform may require different protocols or credentials to authenticate users or agent that attempt to access the content platform data.

In one or more of the various embodiments, each connection agent may be arranged to perform the particular protocol of a content platform and provide the appropriate credentials to access that content platform's data. The particular protocol used by a content platform and the specific required credentials may be determined based on information published or provided by the content platforms.

Accordingly, in one or more of the various embodiments, during the establishment of the distribution, the credentials that enable access to the content platform for a distribution may be associated with the entry point. Further, in some embodiments, the attribution engine may be arranged to provide the credentials for a distribution to the one or more connector agents associated with the content platform of interest.

In one or more of the various embodiments, the connector agents may be arranged to periodically request the current credentials from the attribution engine to ensure they are available if the agent is accessing the content platform. For example, a connector agent may be arranged to request credential information from the attribution engine at various time, such as once a day, every hour, before each access of a content platform, before the first attempt to access a content platform for a given distribution, or the like, or combination thereof.

In one or more of the various embodiments, the connector agents may be arranged to include configuration information that associates a distribution identifier with the appropriate content platform and the required credentials.

At block 904, in one or more of the various embodiments, the connector agents may be arranged to collect raw data from the content platforms. In one or more of the various embodiments, each connector agent may be arranged to include configuration information that enables the connector agent to communicate with a content platform to access the content data for one or more distributions.

In one or more of the various embodiments, connector agents may be arranged to include a custom library or platform engine that may be customized for a particular content platform. Accordingly, in one or more of the various embodiments, each individual connector agent may be arranged to perform actions tailored to establish a connection with one or more content platforms and access the content data associated with individual distributions.

In one or more of the various embodiments, the particular actions performed to access the content data of a content platform may be published or otherwise known. Accordingly, in one or more of the various embodiments, the platform engine of each connector agent may be arranged to conform to the published or otherwise known standards for accessing the content platforms.

In one or more of the various embodiments, since the connector agents may be arranged to communicate to the content platforms over a network, in some cases, the availability of the network or lack thereof may interrupt or delay one or more connector agents from collecting the data. Accordingly, in one or more of the various embodiments, if the quality of the network communication to with the content platforms is below one or more threshold values (e.g., throughput, packet loss, latency, bandwidth, dropped connections, or the like), the connector agent may be arranged to postpone data collection until the quality of the network communication with the content platform is restored. In some embodiments, if the network communication with the content platforms is determined to be unreliable or ineffective, one or more connector agents may be arranged to select from one or more backup or alternative network configurations. Thus, in one or more of the various embodiments, if a connection agent is having problems establishing a connection (of satisfactory quality) with a content platform, the connection agent may try different network configurations that may result in a satisfactory connection. For example, in some embodiments, a connection agent may be arranged to try one or more different DNS servers, one or more different network routes, one or more different hostnames or IP addresses for the content platform, or the like, or combination thereof. In one or more of the various embodiments, that alternative network configuration may be stored in configuration information accessible by the connection agents, such as, configuration files, databases, or the like.

In some embodiments, if a connection agent is unable to establish a network connection with a content platform, it may communicate a message to another connector agent to begin collecting the data. Accordingly, in one or more of the various embodiments, a connection agent located in one geographic area may hand off the data collection to another connection agent location in an alternative geographic area.

At block 906, in one or more of the various embodiments, the connector agents may be arranged to normalize the content data. In one or more of the various embodiments, the platform engine incorporated into each connector agent may be arranged to accept content data from a content platform and transform it to conform to a normalized data model.

In one or more of the various embodiments, since different content platforms may be arranged their data differently, the connector agents may transform this data into a format closer to the unified metrics format used by unified analytics engines, such as unified analytics engine 324. In some cases, the raw data provided by the content platform may employ different names/labels, units of measure, semantics, or the like, or combination thereof, as compared to the data model used by the unified analytics engine. Accordingly, in some embodiments, the connector agents may be arranged to execute the necessary transformations to provide data in a format useable by the unified analytics engine.

In one or more of the various embodiments, there may remain processing and analysis that may be performed by the unified analytics engine, however, the results produced by connector agents may be considered unified in the sense that content data from the different content platform has the same fields, value types, scale/units, or the like.

At block 908, in one or more of the various embodiments, the normalized content data may be stored. In one or more of the various embodiments, connector agents may be arranged to store the processed content data in a data store. In one or more of the various embodiments, the data store should be accessible by one or more of the connector agents and their associated unified analytics engine.

In some embodiments, the data store may be located on computers/computer storage that may be separate from the connector agents. Accordingly, in some embodiments, the connector agents may communicate the normalized content data to a data store over a network for storage. For example, in some embodiments, one or more connector agents may be arranged to store the normalized content data in a cloud-based storage environment.

Also, in one or more of the various embodiments, one or more of the connector agents may be co-located with the data store used to store the normalized content data. For example, in some embodiments, one or more of the connector agents may store the normalized content data on a local hard-drive, or the like.

Next, in one or more of the various embodiments, control may be returned to a calling process.

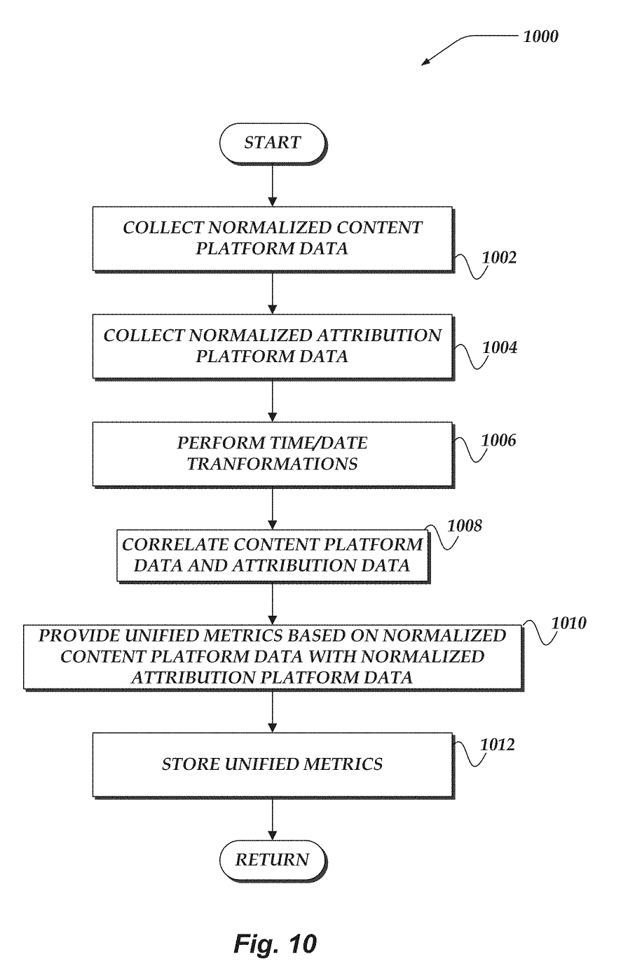

FIG. 10 illustrates an overview flowchart for process 1000 that provides unified metrics based on content platform data and attribution platform data in accordance with at least one of the various embodiments. After a start block, at block 1002, in one or more of the various embodiments, a unified analytics engine may be arranged to collect the normalized content data. In one or more of the various embodiments, the unified analytics engine may be arranged to periodically access the data store that may be holding the normalized content data. Accordingly, in one or more of the various embodiments, it may obtain the normalized content data. In some embodiments, the period of collection may be established based on configuration information. Accordingly, in some embodiments, the normalized content data may be collected at various times, such as semi-hourly, hourly, daily, or the like.

At block 1004, in one or more of the various embodiments, the unified analytics engine may be arranged to collect the normalized attribution platform data. In one or more of the various embodiments, the unified analytics engine may collect attribution data. In some embodiments, attribution data may be provided by one or more external attribution services. In some embodiments, an attribution engine that may be part of the same measurement platform as the unified analytics engine. Accordingly, in some embodiments, the unified analytics engine may be arranged to access the attribution data directly from a data store that may be associated with the attribution data.

At block 1006, in one or more of the various embodiments, one or more time/date transformations may be performed on the normalized content platform data and the normalized attribution platform data. In one or more of the various embodiments, as described above, the normalized data may enable common fields, units, or the like to represent content data and attribution data provided from different sources. However, in some embodiments, one or more platforms may use different sample periods or reporting periods. For example, some content platforms may generate report data hourly whereas other content platforms may generate reports daily. Accordingly, in one or more of the various embodiments, if the reported time periods are different from the time periods of the unified analytics engine, the data may be transformed to conform to the requirements of the unified analytics engine.

For example, in one or more of the various embodiments, content platform A may report content activity in hourly intervals while content platform B may report content activity in four hour intervals. If, in this example, the unified analytics engine is configured to use hourly intervals, the content data provided by platform A is already bucketed or grouped into the correct interval. However, the content data provided by platform B needs to be divide into by four to fit it to the correct interval.

Also, in one or more of the various embodiments, some content platforms or attribution platforms may use different time-zones or date time formats. Accordingly, in one or more of the various embodiments, the unified analytics engine may be arranged to adjust the date-time/timestamp information to conform to a single common time-zone. The common time-zone used by the unified analytics engine may be set using configuration information.

At block 1008, in one or more of the various embodiments, the content data and the attribution data may be correlated together and associated with a content distribution. In one or more of the various embodiments, an application identifier associated with the attribution data may associated with the content data may be employed to perform the correlation. In some embodiments, if the application identifier is unavailable, another identifier, such as, a distribution identifier or tag, or the like, may be used as a correlation key.

At block 1010, in one or more of the various embodiments, unified metrics may be provided based on the correlated normalized content platform data and the normalized attribution platform data. In one or more of the various embodiments, the unified analytics engine may be arranged to merge the normalized content data and the normalized attribution data into a collection of unified metrics. In one or more of the various embodiments, metrics representing content activity and metrics representing attribution data may be included in single data structure.

At block 1012, in one or more of the various embodiments, the unified metrics may be stored. In one or more of the various embodiments, as described above the unified metrics may be stored in a data store that may be accessible to authorized users. In one or more of the various embodiments, the stored unified metrics may be employed to provide one or more reports to users.

Next, control may be returned to a calling process.

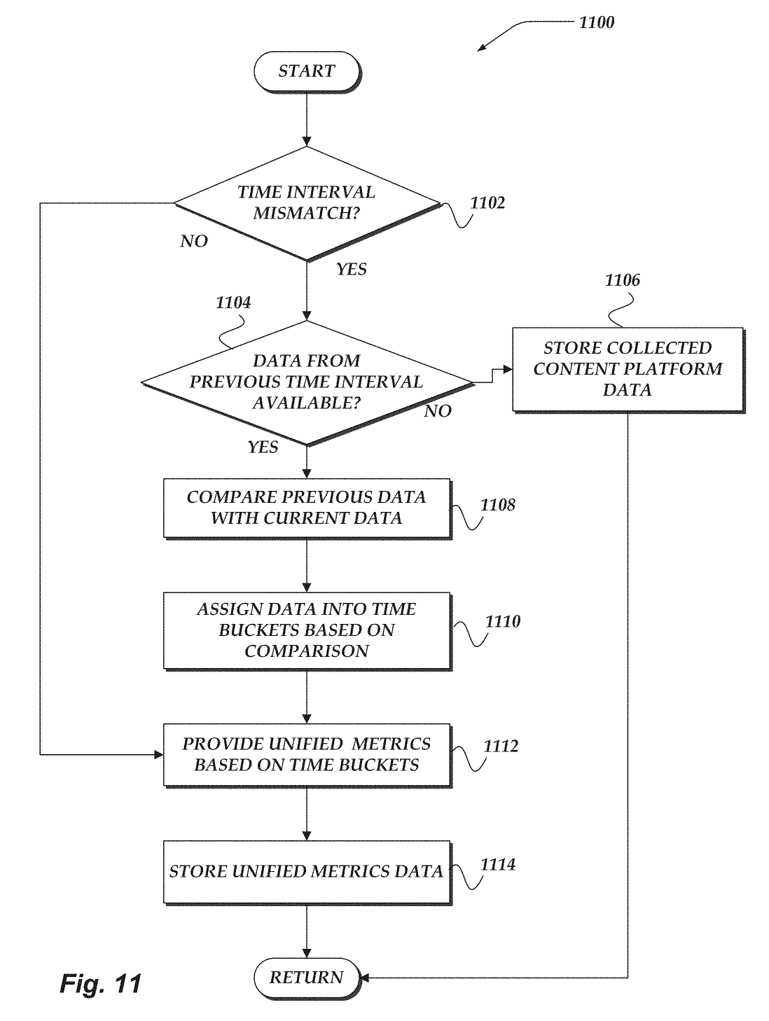

FIG. 11 illustrates a flowchart for process 1100 that normalizes content platform data for time and date in accordance with at least one of the various embodiments. After a start block, at decision block 1102, in one or more of the various embodiments, if there is a time interval mismatch between the unified analytics engine and a content platform, control may flow to decision block 1104; otherwise, control may flow to block 1112.

In one or more of the various embodiments, a time interval mismatch may occur if a content platform generates reports at time intervals that may be different than time intervals used for the unified metrics. For example, in some embodiments, a content platform that produces one activity report per day may be considered to have an interval mismatch if the unified analytics engine is configured to use hourly time intervals for unified metrics.

At decision block 1104, in one or more of the various embodiments, if content platform data from a previous pull period is available, control may flow to block 1108; otherwise, control may flow to block 1106.

In one or more of the various embodiments, even though content platform produces a single report per a given time interval, it may be arranged to append real-time results to the current interval file. Thus, in one or more of the various embodiments, even though there is just one file/report per a given interval, the report/file may be updated as new activity occurs.

At block 1106, in one or more of the various embodiments, the collected content platform data may be stored. In one or more of the various embodiments, if previously collected data is unavailable, the collected data may be stored.

At block 1108, in one or more of the various embodiments, the previously collected content platform data may be compared to the current content platform data. In one or more of the various embodiments, since there is previously pulled data available, the connector agent may be arranged to compare the previously pulled data with the currently data to determine the change in values for correct interval. For example, if a content platform provides one report per 24 hours, a connector agent checking the values each hour may determine the activity changes between checks (pulls) to determine activity at a given interval. For example, if the content platform provides a report named 20160801-actvity.log a first pull may establish an initial baseline value. Then at the next interval the connector agent may pull the same report again. The difference between the first (e.g., the baseline) and the current pull of the report may be used as the metric value for the particular time interval.

At block 1110, in one or more of the various embodiments, the content platform data may be assigned to one or more time buckets based the comparison of the previously collected content platform data to the current content platform data. In one or more of the various embodiments, as the connector agent collects content data from the content platforms, the data (e.g., metrics) may be associated with a time bucket that correspond to the time interval when the data was collected.

At block 1112, in one or more of the various embodiments, unified metrics may be provided based on the time buckets. In one or more of the various embodiments, the unified analytics engine may be arranged to collect the time bucketed metrics and use them to provide unified metrics.

At block 1114, in one or more of the various embodiments, the unified metrics may be stored. As described above, the unified analytics engine may be arranged to store the unified metrics such that they may be made available to authorized users or authorized services. Next, in some embodiments, control may be returned to a calling process.

It will be understood that each block of the flowchart illustration, and combinations of blocks in the flowchart illustration, can be implemented by computer program instructions. These program instructions may be provided to one or more processors, including one or more special purpose processers to produce a machine, such that the instructions, which execute on the one or more processors, create means for implementing the actions specified in the flowchart block or blocks. The computer program instructions may be executed by the one or more processors to cause a series of operational steps to be performed by the one or more processors to produce a computer-implemented process such that the instructions, which execute on the one or more processors to provide steps for implementing the actions specified in the flowchart block or blocks. The computer program instructions may also cause at least some of the one or more processors to perform the operational steps shown in the blocks of the flowchart in parallel. Moreover, some of the steps may also be performed across more than one processor, such as might arise in a multi-processor computer system and/or multi-core hardware processor. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of actions for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

Further, in one or more embodiments (not shown in the figures), the logic in the illustrative flowcharts may be executed using one or more embedded logic hardware devices instead of a CPU, such as, an Application Specific Integrated Circuit (ASIC), Field Programmable Gate Array (FPGA), Programmable Array Logic (PAL), or the like, or combination thereof. The one or more embedded logic hardware devices may directly execute embedded logic to perform actions described above. In at least one embodiment, one or more microcontrollers may be arranged to directly execute their own embedded logic to perform actions and access their own internal memory and their own external Input and Output Interfaces (e.g., hardware pins and/or wireless transceivers) to perform actions, such as System On a Chip (SOC), or the like.

What is claimed as new and desired to be protected by Letters Patent of the United States is:

1. A method for managing user interactions with applications over a network using a network computer having one or more processors that perform actions, comprising:
employing an analytics engine to perform actions, including:
providing a distribution identifier for content distributed to one or more platforms that provide the content to one or more users, wherein the distribution identifier is associated with an application identifier;
collecting content data that is associated with the distribution identifier from a remote data store, wherein the content data is based on raw content data associated with user interactions and provided by the one or more platforms, and wherein one or more portions of the content data is normalized to conform to a unified data model;
collecting attribution data, from an attribution engine, for an application that is both associated with the content and accessed by the one or more users, wherein the attribution data is associated with the application identifier;
correlating the content data to the attribution data based on the application identifier;
transforming one or more of fields of the attribution data, or one or more fields of the content data into one or more unified metric values; and
providing one or more reports based on the unified metric values.

2. The method of claim 1, further comprising:
employing one or more connector agents to perform actions, including:
collecting the raw content data from the one or more platforms;
transforming the raw content data into the content data that partially conforms to the unified data model; and
storing the content data on the remote data store.

3. The method of claim 1, further comprising, transforming one or more of, one or more timestamp values associated with the content data, or one or more timestamp values associated with the attribution data to a configured time format.

4. The method of claim 1, wherein collecting the attribution data, further comprises, employing the attribution engine to accumulate the attribution data that is provided by a metrics engine, wherein the attribute engine is separate from the one or more platforms.

5. The method of claim 1, wherein transforming the one or more fields of the attribution data, or the one or more fields of the content data, further comprises, including one or more metric values, that are unavailable to the platform, in the one or more unified metric values.

6. The method of claim 1, wherein providing the one or more reports, further comprises:
storing the one or more unified metric values in a separate data store that is separately accessible for use in other reports.

7. Method of claim 1, further comprising:
providing one or more credentials that provide access to the one or more platforms;
associating the one or more credentials with the content distribution; and
communicating the one or more credentials to one or more connector agents arranged to collect raw content data from the one or more platforms.

8. The method of claim 1, wherein the analytics engine performs further actions comprising providing one or more entry points for distributing content to the one or more platforms that provide the content to one or more applications that accessible to the one or more users, wherein the one or more entry points are associated with the distribution identifier.

9. A system for managing user interactions with applications, comprising:
a network computer, comprising:
a transceiver that communicates over the network;
a memory that stores at least instructions; and
one or more processor devices that execute instructions that perform actions, including:
employing an analytics engine to perform actions, including:
providing a distribution identifier for content distributed to one or more platforms that provide the content to one or more users, wherein the distribution identifier is associated with an application identifier;
collecting content data that is associated with the distribution identifier from a remote data store, wherein the content data is based on raw content data associated with user interactions and provided by the one or more platforms, and wherein one or more portions of the content data is normalized to conform to a unified data model;
collecting attribution data, from an attribution engine, for an application that is both associated with the content and accessed by the one or more users, wherein the attribution data is associated with the application identifier;
correlating the content data to the attribution data based on the application identifier;
transforming one or more of fields of the attribution data, or one or more fields of the content data into one or more unified metric values; and
providing one or more reports based on the unified metric values; and
a client computer, comprising:
a client computer transceiver that communicates over the network;
a client computer memory that stores at least instructions; and
one or more processor devices that execute instructions that perform actions, including:
executing the application that is both associated with the content and accessed by the one or more users; and
communicating one or more application events to the attribution engine.

10. The system of claim 9, further comprising:
employing one or more connector agents to perform actions, including:
collecting the raw content data from the one or more platforms;
transforming the raw content data into the content data that partially conforms to the unified data model; and
storing the content data on the remote data store.

11. The system of claim 9, wherein the one or more network computer processor devices execute instructions that perform actions, further comprising, transforming one or more of, one or more timestamp values associated with the content data, or one or more timestamp values associated with the attribution data to a configured time format.

12. The system of claim 9, wherein collecting the attribution data, further comprises, employing the attribution engine to accumulate the attribution data that is provided by a metrics engine, wherein the attribute engine is separate from the one or more platforms.

13. The system of claim 9, wherein transforming the one or more fields of the attribution data, or the one or more fields of the content data, further comprises, including one or more metric values, that are unavailable to the platform, in the one or more unified metric values.

14. The system of claim 9, wherein providing the one or more reports, further comprises:
storing the one or more unified metric values in a separate data store that is separately accessible for use in other reports.

15. The system of claim 9, wherein the one or more network computer processor devices execute instructions that perform actions, further comprising:
providing one or more credentials that provide access to the one or more platforms;
associating the one or more credentials with the content distribution; and
communicating the one or more credentials to one or more connector agents arranged to collect raw content data from the one or more platforms.

16. The system of claim 9, wherein the analytics engine performs further actions comprising providing one or more entry points for distributing content to the one or more platforms that provide the content to one or more applications that accessible to the one or more users, wherein the one or more entry points are associated with the distribution identifier.

17. A processor readable non-transitory storage media that includes instructions for managing user interactions with application, wherein execution of the instructions by one or more hardware processors performs actions, comprising:
employing an analytics engine to perform actions, including:
providing a distribution identifier for content distributed to one or more platforms that provide the content to one or more users, wherein the distribution identifier is associated with an application identifier;
collecting content data that is associated with the distribution identifier from a remote data store, wherein the content data is based on raw content data associated with user interactions and provided by the one or more platforms, and wherein one or more portions of the content data is normalized to conform to a unified data model;
collecting attribution data, from an attribution engine, for an application that is both associated with the content and accessed by the one or more users, wherein the attribution data is associated with the application identifier;
correlating the content data to the attribution data based on the application identifier;
transforming one or more of fields of the attribution data, or one or more fields of the content data into one or more unified metric values; and
providing one or more reports based on the unified metric values.

18. The media of claim 17, further comprising:
employing one or more connector agents to perform actions, including:
collecting the raw content data from the one or more platforms;
transforming the raw content data into the content data that partially conforms to the unified data model; and
storing the content data on the remote data store.

19. The media of claim 17, further comprising, transforming one or more of, one or more timestamp values associated with the content data, or one or more timestamp values associated with the attribution data to a configured time format.

20. The media of claim 17, wherein collecting the attribution data, further comprises, employing the attribution engine to accumulate the attribution data that is provided by a metrics engine, wherein the attribute engine is separate from the one or more platforms.

21. The method of claim 17, wherein transforming the one or more fields of the attribution data, or the one or more fields of the content data, further comprises, including one or more metric values, that are unavailable to the platform, in the one or more unified metric values.

22. The media of claim 17, wherein providing the one or more reports, further comprises:
storing the one or more unified metric values in a separate data store that is separately accessible for use in other reports.

23. The media of claim 17, further comprising:
providing one or more credentials that provide access to the one or more platforms;
associating the one or more credentials with the content distribution; and
communicating the one or more credentials to one or more connector agents arranged to collect raw content data from the one or more platforms.

24. A network computer for managing user interactions with applications, comprising:
a transceiver that communicates over the network;
a memory that stores at least instructions; and
one or more processor devices that execute instructions that perform actions, including:
employing an analytics engine to perform actions, including:
providing a distribution identifier for content distributed to one or more platforms that provide the content to one or more users, wherein the distribution identifier is associated with an application identifier;
collecting content data that is associated with the distribution identifier from a remote data store, wherein the content data is based on raw content data associated with user interactions and provided by the one or more platforms, and wherein one or more portions of the content data is normalized to conform to a unified data model;
collecting attribution data, from an attribution engine, for an application that is both associated with the content and accessed by the one or more users, wherein the attribution data is associated with the application identifier;
correlating the content data to the attribution data based on the application identifier;
transforming one or more of fields of the attribution data, or one or more fields of the content data into one or more unified metric values; and
providing one or more reports based on the unified metric values.

25. The network computer of claim 24, further comprising:
employing one or more connector agents to perform actions, including:
collecting the raw content data from the one or more platforms;
transforming the raw content data into the content data that partially conforms to the unified data model; and
storing the content data on the remote data store.

26. The network computer of claim 24, further comprising, transforming one or more of, one or more timestamp values associated with the content data, or one or more timestamp values associated with the attribution data to a configured time format.

27. The network computer of claim 24, wherein collecting the attribution data, further comprises, employing the attribution engine to accumulate the attribution data that is provided by a metrics engine, wherein the attribute engine is separate from the one or more platforms.

28. The network computer of claim 24, wherein transforming the one or more fields of the attribution data, or the one or more fields of the content data, further comprises, including one or more metric values, that are unavailable to the platform, in the one or more unified metric values.

29. The network computer of claim 24, wherein providing the one or more reports, further comprises:
storing the one or more unified metric values in a separate data store that is separately accessible for use in other reports.

30. The network computer of claim 24, further comprising:
providing one or more credentials that provide access to the one or more platforms;
associating the one or more credentials with the content distribution; and
communicating the one or more credentials to one or more connector agents arranged to collect raw content data from the one or more platforms.
